(19) United States
(12) Patent Application Publication
(10) Pub. No.: US 2025/0196496 A1
(43) Pub. Date: Jun. 19, 2025

(54) ELEMENT SUBSTRATE AND LIQUID EJECTION HEAD

(71) Applicant: CANON KABUSHIKI KAISHA, Tokyo (JP)

(72) Inventors: SHINYA IWAHASHI, Kanagawa (JP); TAKERU YASUDA, Kanagawa (JP); YUZURU ISHIDA, Kanagawa (JP); KOJI TAKASE, Kanagawa (JP)

(21) Appl. No.: 18/962,414

(22) Filed: Nov. 27, 2024

(30) Foreign Application Priority Data
Dec. 14, 2023 (JP) 2023-211136

(51) Int. Cl. B41J 2/14

(52) U.S. Cl. CPC B41J 2/14072; B41J 2/1408; B41J 2/14129; B41J 2002/14491

(57) ABSTRACT

An element substrate for a liquid ejection head that ejects liquid includes a heating resistor element configured to generate energy for ejecting liquid by generating heat, a wiring layer configured to supply electric power to the heating resistor element, and a connection member including a first connection portion connected to the heating resistor element and a plurality of second connection portions connected to the wiring layer, and configured to electrically connect the heating resistor element and the wiring layer. The connection member has branched end portions that extend, on a wiring layer side thereof, and is connected to the wiring layer by the plurality of the second connection portions.

### BACKGROUND OF THE INVENTION

### Field of the Invention

The present invention relates to an element substrate for a liquid ejection head.

### Description of the Related Art

As apparatuses including liquid ejection heads that eject liquid, recording apparatuses that perform recording by ejecting ink onto recording media are known. A thermal method is known as one of liquid ejection methods used in such recording apparatuses. In the thermal method, for example, a liquid foaming phenomenon is induced by thermal energy generated by heating resistor elements provided on an element substrate of the liquid ejection head, and this liquid foaming phenomenon is used for ejecting the liquid.

As an element substrate of the liquid ejection head, there is known an element substrate including, in addition to the heating resistor elements, a wiring layer for supplying electric current to the heating resistor elements and connection members for electrically connecting the heating resistor elements and the wiring layer. Japanese Patent Application Laid-open No. 2016-137705 discloses a configuration in which a plug formed of tungsten or the like is used as a connection member.

### SUMMARY OF THE INVENTION

However, in the configuration described above, since a plurality of connection members are positioned at intervals from one another, current density in the vicinity of the connection members in the heating resistor element becomes sparse, and this can lead to a decrease in energy generation efficiency.

In view of the above problem, an object of the present invention is to provide an element substrate for a liquid ejection head that prevents a decrease in energy generation efficiency.

To achieve the above object, an element substrate of the present invention includes:
a heating resistor element configured to generate energy for ejecting liquid by generating heat;
a wiring layer configured to supply electric power to the heating resistor element; and
a connection member including a first connection portion connected to the heating resistor element and a plurality of second connection portions connected to the wiring layer and configured to electrically connect the heating resistor element and the wiring layer,
wherein the connection member has branched end portions that extend, on a wiring layer side thereof, and is connected to the wiring layer by the plurality of the second connection portions.

According to the present invention, an element substrate for a liquid ejection head that prevents a decrease in energy generation efficiency can be provided.

Further features of the present invention will become apparent from the following description of exemplary embodiments with reference to the attached drawings.

### BRIEF DESCRIPTION OF THE DRAWINGS

FIG. 1 illustrates an external perspective view of a recording apparatus;

FIGS. 2A and 2B are explanatory diagrams illustrating a recording head;

FIG. 3 illustrates a plan view and a partially enlarged view of an element substrate;

FIGS. 4A to 4D illustrate a configuration of an element substrate according to Comparative Example 1;

FIGS. 5A to 5D illustrate a configuration of an element substrate according to Comparative Example 2;

FIGS. 6A to 6C illustrate a configuration of an element substrate according to Example 1;

FIGS. 7A to 7C illustrate a configuration of an element substrate according to Example 2;

FIGS. 8A to 8C illustrate a configuration of an element substrate according to Example 3; and

FIGS. 9A and 9B are explanatory diagrams illustrating a method for manufacturing plugs.

### DESCRIPTION OF THE EMBODIMENTS

Hereinafter, a description will be given, with reference to the drawings, of various exemplary embodiments (examples), features, and aspects of the present disclosure. However, the sizes, materials, shapes, their relative arrangements, or the like of constituents described in the embodiments may be appropriately changed according to the configurations, various conditions, or the like of apparatuses to which the disclosure is applied. Therefore, the sizes, materials, shapes, their relative arrangements, or the like of the constituents described in the embodiments do not intend to limit the scope of the disclosure to the following embodiments.

In this specification, a term “recording” (also referred to as “printing”) refers to not only the case of forming significant information such as characters and figures but also the case of forming insignificant information. Further, the term “recording” broadly refers to the case of forming an image, a design, a pattern, or the like on a recording medium or processing a medium, regardless of whether or not the subject is made apparent so as to be visually perceived by a human.

Hereinafter, as an embodiment of the present invention, a configuration of a case in which the present invention is applied to an inkjet recording apparatus that performs a recording operation by ejecting ink as liquid onto a recording medium will be described. However, the recording apparatus to which the present invention can be applied is not limited to the inkjet recording apparatus, and may be any recording apparatus that performs a recording operation using a liquid ejection head that has a heating resistor element and ejects liquid. For example, the recording apparatus may be a fusion thermal transfer recording apparatus, a sublimation thermal transfer recording apparatus, or the like. The recording apparatus may be a manufacturing apparatus for manufacturing, for example, a color filter, an electronic device, an optical device, a microstructure, or the like by a predetermined recording method. The recording apparatus may be an apparatus that forms a three-dimensional image from 3D data.

### Recording Apparatus

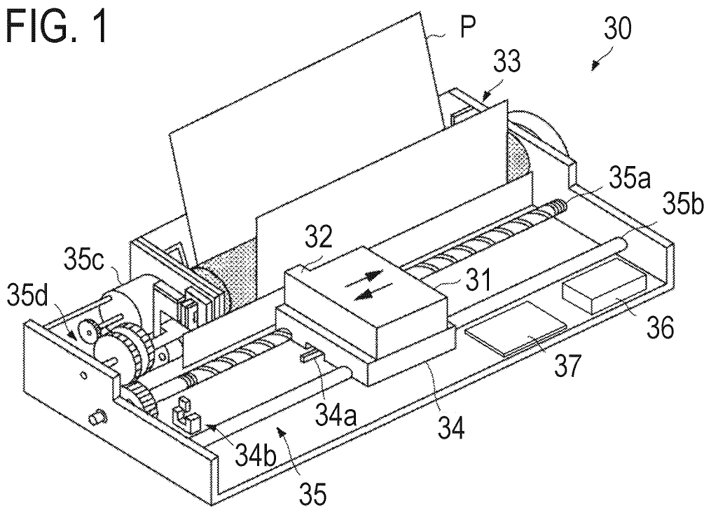

First, a basic configuration of a recording apparatus 30 according to an embodiment of the present invention will be described. FIG. 1 illustrates an external perspective view of the recording apparatus 30 according to the embodiment. The recording apparatus 30 is an inkjet recording apparatus that performs recording on a recording medium P by ejecting ink.

The recording apparatus 30 includes an ink tank 31 as an ink storage portion for holding ink therein, and a recording head 32. The ink tank 31 and the recording head 32 are configured as one unit, and this unit is mounted on a carriage 34. The recording head 32 is a liquid ejection head that performs recording by ejecting the ink contained in the ink tank 31 onto the recording medium P. The carriage 34 can reciprocate in directions (directions indicated by arrows in FIG. 1) perpendicular to a conveyance direction of the recording medium P by a drive unit 35.

The drive unit 35 includes a lead screw 35a and a guide shaft 35b extending in a movement direction of the carriage 34. The lead screw 35a engages with a threaded hole (not illustrated) of the carriage 34, and the carriage 34 moves by the rotation of the lead screw 35a. The drive unit 35 includes a motor 35c and a gear train 35d as a rotation mechanism of the lead screw 35a. The guide shaft 35b guides the movement of the carriage 34. An optical sensor 34b for detecting a detection piece 34a of the carriage 34 is disposed at one end of the movement range of the carriage 34, and a detection result is used for controlling the movement of the carriage 34.

A conveyance unit 33 conveys the recording medium P in the conveyance direction. The conveyance unit 33 includes a motor (not illustrated) as a drive source and conveyance rollers (not illustrated) rotated by a driving force of the motor, and the recording medium P is conveyed by the rotation of the conveyance rollers. In the recording apparatus 30, the conveyance direction of the recording medium P is approximately perpendicular to the movement direction of the carriage 34 (recording head 32).

The recording apparatus 30 includes an internal power supply 36 that supplies power to be consumed by the recording apparatus 30, and a control circuit 37 that controls the recording apparatus 30. The control circuit 37 alternately performs an operation of moving the recording head 32 and ejecting the ink by moving the carriage 34 and an operation of conveying the recording medium P so as to record an image on the recording medium P.

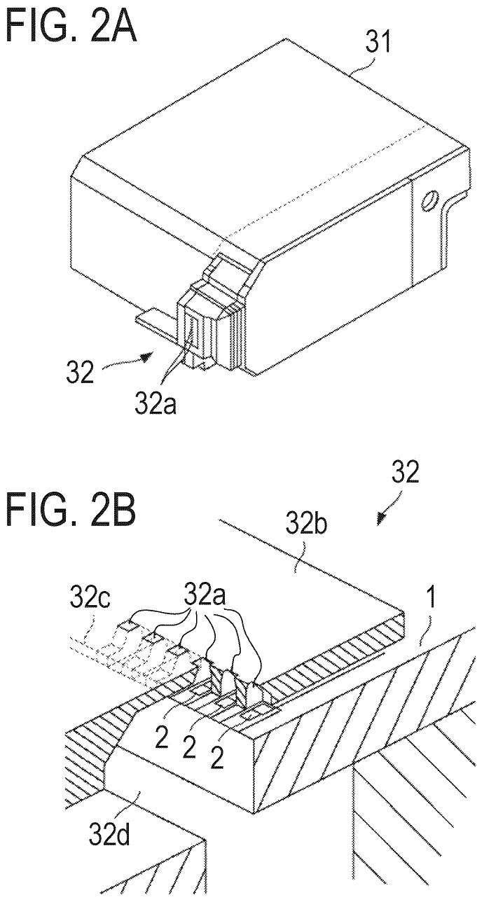

FIGS. 2A and 2B are explanatory diagrams illustrating the recording head 32. FIG. 2A is a perspective view of the ink tank 31 and the recording head 32, which are configured as one unit. The ink tank 31 and the recording head 32 can be separated from each other at the position of a broken line. The recording head 32 is a liquid ejection head having a plurality of ink ejection ports 32a for ejecting ink. FIG. 2B is a cutaway view of the recording head 32 illustrating a structure of the periphery of the ink ejection ports 32a.

The recording head 32 includes a flow path forming member 32b and an element substrate 1, which is a substrate for the liquid ejection head. The flow path forming member 32b is provided on the element substrate 1, and forms the ink ejection ports 32a, a flow path 32c for supplying ink to each ink ejection port 32a, and a common liquid chamber 32d.

The element substrate 1 is provided with a plurality of heating resistor elements 2 corresponding to the respective ink ejection ports 32a. The individual heating resistor element 2 of the present embodiment is an element that generates energy for ejecting liquid (ink) when electric power is supplied, and in particular, the heating resistor element 2 is an electrothermal conversion element. The electrothermal conversion element heats up when energized and foams the ink, and this foaming energy causes the ink to be ejected from the ink ejection port 32a. The liquid ejection method of the recording head 32 is the thermal method using thermal energy generated by the heating resistor element 2.

### Element Substrate

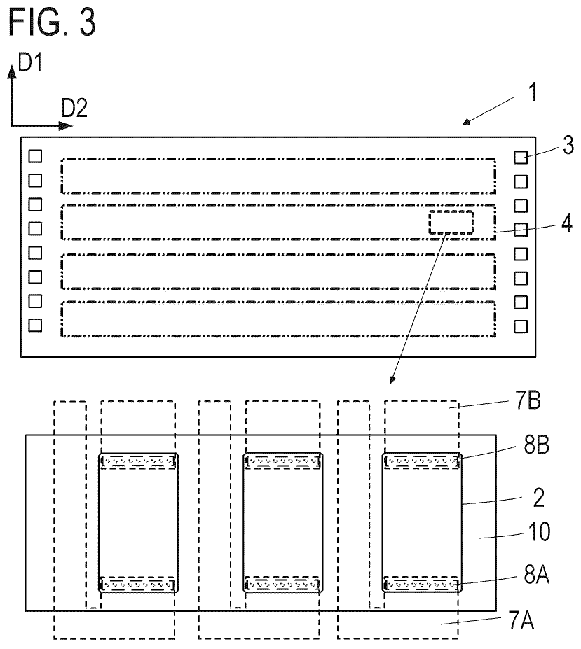

Next, a basic configuration of the element substrate 1 will be described. FIG. 3 illustrates a plan view and a partially enlarged view of the element substrate 1. The element substrate 1 has a rectangular shape in a plan view, and a pad row constituted by a plurality of electrode pads 3 is formed in each end portion of the element substrate 1 in the longitudinal direction. Note that the plan view of the element substrate 1 refers to a view of the element substrate 1 seen from a direction perpendicular to a surface of the element substrate 1 on which the pad row is formed. The electrode pads 3 are electrical contacts with an external device (control circuit or the like).

A placement region 4 for arranging the heating resistor elements 2 corresponding to the row of the plurality of ink ejection ports 32a is formed in the central portion in the lateral direction perpendicular to the longitudinal direction of the element substrate 1. In FIG. 3, a plurality of placement regions 4 are indicated by two-dot chain lines. Further, FIG. 3 illustrates an enlarged view of the periphery of three heating resistor elements 2 arranged in one of the placement regions 4. A region including one heating resistor element 2 can be called a pressure generation portion because a pressure for ejecting ink is generated therein, and it can be said that three pressure generation portions are illustrated in FIG. 3. The placement region 4 can be called a pressure generation region because these pressure generation portions are formed in a row in the longitudinal direction of the element substrate 1.

The element substrate 1 includes a wiring layer 7, plugs 8, and a conductive layer 10. In the partially enlarged view illustrated in the lower portion of FIG. 3, regions where the wiring layer 7 is formed are indicated by dotted lines. In the plan view of the element substrate 1, the wiring layer 7 and a plurality of plugs 8 are arranged at positions where the wiring layer 7 and the plurality of plugs 8 overlap each other at one end of the individual heating resistor element 2 in a first direction D1, and the wiring layer 7 and a plurality of plugs 8 are also arranged at positions where the wiring layer 7 and the plurality of plugs 8 overlap each other at the other end of the individual heating resistor element 2 in the first direction D1. The plurality of plugs 8 are arranged side by side in a second direction D2, which intersects the first direction D1, at each end of the heating resistor element 2 in the first direction D1. In the present embodiment, the first direction D1 is parallel to the lateral direction of the element substrate 1, and the second direction D2 is parallel to the longitudinal direction of the element substrate 1. The stacking direction of the layers of the element substrate 1 is a direction perpendicular to the first direction D1 and the second direction D2. Hereinafter, the wiring layer 7 and the plugs 8 provided at one end of the heating resistor element 2 are referred to as a wiring layer 7A and plugs 8A, and the wiring layer 7 and the plugs 8 provided at the other end of the heating resistor element 2 are referred to as a wiring layer 7B and plugs 8B, and these components will be distinguished as needed in the following description.

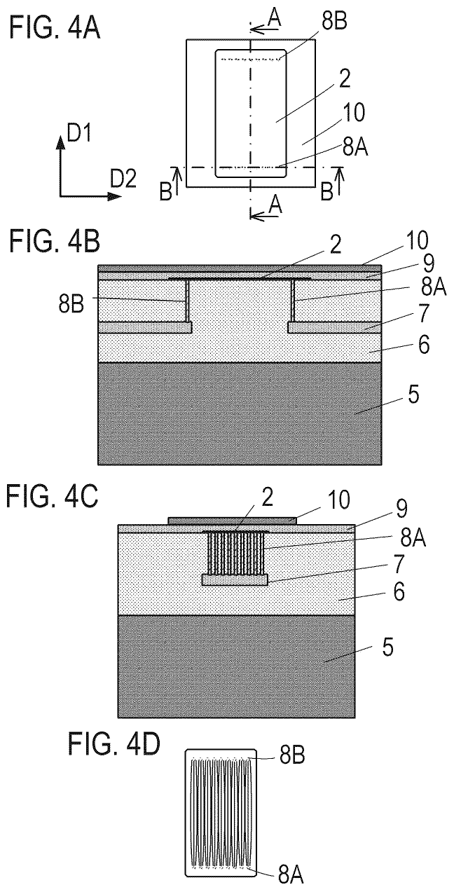

The configuration of the element substrate 1 will be described in more detail with reference to FIGS. 4A and 4B. FIG. 4A illustrates the periphery of one heating resistor element 2 in a comparative example, and FIG. 4B is a sectional view taken along a line A-A in FIG. 4A, which will be described in detail below. The element substrate 1 is a stacked body including a plurality of functional layers such as a base substrate 5, an intermediate layer 6, an insulating layer 9, and a conductive layer 10 in order from the lower layer. The element substrate 1 is provided with the heating resistor elements 2 and the plugs 8. In the following description, for convenience, the base substrate 5 side is described as a lower layer and the conductive layer 10 side is described as an upper layer in the stacking direction of the stacked body. However, this structure does not indicate the posture of the element substrate 1 during use.

The base substrate 5 is a plate-like member made of, for example, Si (silicon). A circuit (not illustrated) for selectively driving each heating resistor element 2 is formed on the base substrate 5. The circuit includes a drive element composed of a semiconductor element such as a switching transistor.

The intermediate layer 6 includes the wiring layer 7, and is formed on the base substrate 5. The wiring layer 7 is made of, for example, a material containing aluminum as a main component, more specifically, AlCu (copper aluminum), for example. The wiring layer 7 has a thickness of, for example, approximately 0.2 μm to 1.0 μm. The intermediate layer 6 constitutes a heat storage layer formed of, for example, SiO as a main component. The upper surface of the intermediate layer 6 is a flat surface. The element substrate 1 may include a plurality of heat storage layers in which a wiring layer is embedded. The upper portion of the intermediate layer 6 above the wiring layer 7 has a thickness of, for example, approximately 0.5 μm to 2.0 μm. The intermediate layer 6 may include a plurality of heat storage layers in which wiring layers are embedded.

The layers placed on the upper side of the intermediate layer 6 include the heating resistor element 2, the insulating layer 9, and the conductive layer 10. The heating resistor element 2 is a film having a thickness of, for example, approximately 10 to 100 nm and contains, for example, tantalum silicon nitride (TaSiN) as a main component. The heating resistor element 2 is placed on the flattened upper surface (the surface) of the intermediate layer 6.

The heating resistor element 2 and the wiring layer 7 are connected to each other by a plurality of plugs 8. The plugs 8 are connection members formed to penetrate from the upper surface of the intermediate layer 6 to the wiring layer 7. The individual plug 8 includes, for example, a contact metal film that is in contact with the corresponding wiring layer 7, a barrier metal film, and a plug film that is a main constituent element. The contact metal film can be formed of, for example, titanium (Ti) having a thickness of approximately 10 to 50 nm. The barrier metal film can be formed of, for example, titanium nitride (TiN) having a thickness of approximately 50 to 100 nm. The plug film can be formed of, for example, a material such as tungsten (W). The plug film is formed to have a sufficient film thickness to fill the hole opened in the intermediate layer 6 by etching.

The wiring layer 7A is placed at a position where the wiring layer 7A overlaps a first end portion of the heating resistor element 2 in the first direction D1, and the wiring layer 7B is placed at a position where the wiring layer 7B overlaps a second end portion of the heating resistor element 2 on the opposite side to the first end portion. The wiring layer 7A is connected to the heating resistor element 2 via the plugs 8A, and the wiring layer 7B is connected to the heating resistor element 2 via the plugs 8B. The power is supplied to the heating resistor element 2 by causing a current to flow through, for example, the wiring layer 7A, the plugs 8A, the heating resistor element 2, the plugs 8B, and the wiring layer 7B in this order. The flow of the current causes the heating resistor element 2 to generate heat, and ink supplied from the common liquid chamber 32d, which is a supplying port, is foamed and ejected from the ink ejection port 32a.

The insulating layer 9 entirely covers the placement region 4. The insulating layer 9 has a thickness of, for example, approximately 100 to 350 nm, and is a film containing silicon nitride (SiN) as a main component. In the thermal method, in order to reduce power consumption, the energy for ejecting liquid needs to be efficiently transmitted to the liquid. For this purpose, it is preferable that the insulating layer 9 be thinly formed.

The conductive layer 10 is an anti-cavitation layer formed on the insulating layer 9 such that the conductive layer 10 covers the heating resistor element 2. The conductive layer 10 has a thickness of, for example, approximately 100 to 300 nm, and is a film containing tantalum (Ta), iridium (Ir), or the like as a main component. In the present embodiment, the conductive layer 10 is placed in a strip shape.

Hereinafter, a plurality of configuration examples of the element substrate 1 in the recording head 32 of the recording apparatus 30 configured as described above will be described. First, configurations of Comparative Example 1 and Comparative Example 2 will be described, and then, configurations of Example 1, Example 2, and Example 3, which are examples of the present invention, will be described.

### Comparative Example 1

First, a configuration of an element substrate 1 according to Comparative Example 1 will be described. FIGS. 4A to 4D illustrate a configuration of the element substrate 1 according to Comparative Example 1. FIG. 4A illustrates the periphery of one heating resistor element 2 in Comparative Example 1. FIG. 4B is a sectional view illustrating a cross section taken along a line A-A in FIG. 4A, the cross section being parallel to the first direction D1. FIG. 4C is a sectional view illustrating a cross section taken along a line B-B in FIG. 4A, the cross section being parallel to the second direction D2. FIG. 4D is an explanatory diagram illustrating current distribution in the heating resistor element 2.

In Comparative Example 1, the plug 8, which is a connection member, is a hole-type plug, and nine plugs 8 are provided in each of the first end portion and the second end portion of one heating resistor element 2 in the first direction D1. The plugs 8 are independent of one another. Therefore, there are nine connection portions between the plugs 8 and the heating resistor element 2 and nine connection portions between the plugs 8 and the wiring layer 7 in each of the first end portion and the second end portion of the heating resistor element 2. The plugs 8 are formed in approximately the same shape and extend in the stacking direction, and an area of the connection portion of the individual plug 8 to the heating resistor element 2 is the same as that of the connection portion of the individual plug 8 to the wiring layer 7. Note that the area of the connection portion of the plug 8 refers to an area of a portion of the plug 8 connected to another member, and in the present example, the area of the connection portion of the plug 8 indicates the area of the portion of the plug 8 connected to the heating resistor element 2 or the wiring layer 7 when the element substrate 1 is viewed in a plan view. Therefore, a region where the current distribution in the heating resistor element 2 becomes sparse is generated between the plugs in respective plug placement areas, in each of which nine plugs are present as illustrated in FIG. 4D, and this reduces thermal energy generation efficiency.

In the configuration of Comparative Example 1, the plugs 8 are independent of one another, and the current is concentrated on each plug 8. Therefore, when a random failure occurs in the heating resistor element 2 and an excessive current flows through the heating resistor element 2, the plug 8 blows out. When that happens, because the plug 8 melts and disappears together with the surrounding films, the plug 8 functions as a fuse that prevents a potential from being applied to other films such as the conductive layer 10. By functioning as a fuse, the plug 8 can prevent the failure from being transmitted to the other heating resistor elements 2 when a random failure of the heating resistor element 2 occurs.

### Comparative Example 2

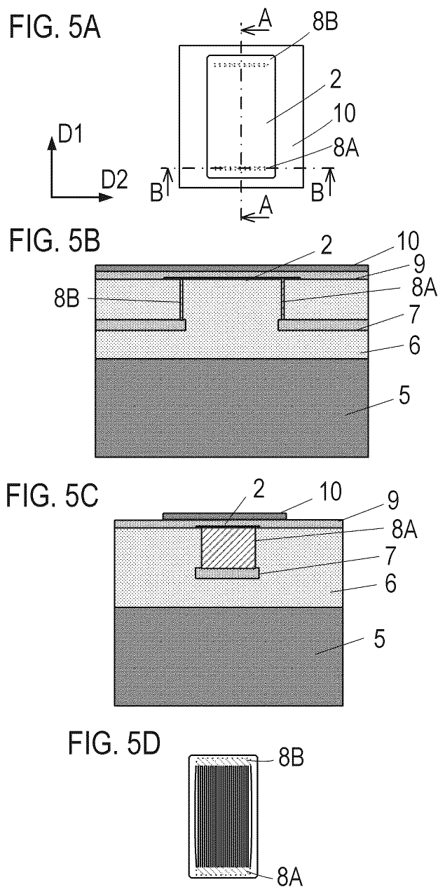

Next, a configuration of an element substrate 1 according to Comparative Example 2 will be described. FIGS. 5A to 5D illustrate a configuration of the element substrate 1 according to Comparative Example 2. FIG. 5A illustrates the periphery of one heating resistor element 2 in Comparative Example 2. FIG. 5B is a sectional view illustrating a cross section taken along a line A-A in FIG. 5A, the cross section being parallel to the first direction D1. FIG. 5C is a sectional view illustrating a cross section taken along a line B-B in FIG. 5A, the cross section being parallel to the second direction D2. FIG. 5D is an explanatory diagram illustrating current distribution in the heating resistor element 2.

In Comparative Example 2, the plug 8, which is a connection member, is a slit-type plug, and one plug 8 is provided in each of the first end portion and the second end portion of one heating resistor element 2 in the first direction D1. Therefore, there are one connection portion between the plug 8 and the heating resistor element 2 and one connection portion between the plug 8 and the wiring layer 7 in each of the first end portion and the second end portion of the heating resistor element 2. As a result, according to the configuration of Comparative Example 2, as compared with the configuration of Comparative Example 1, a region where the current distribution in the heating resistor element 2 becomes sparse is not generated, and instead, the current distribution as illustrated in FIG. 5D is obtained. This increases thermal energy generation efficiency.

In the configuration of Comparative Example 2, because both the connection portion between the plug 8 and the wiring layer 7 and the connection portion between the plug 8 and the heating resistor element 2 are thickly formed, the plug 8 is less likely to blow out, and the surrounding film is likely to remain incompletely. Thus, the possibility of conducting with other films such as the conductive layer 10 increases. For example, when the melted plug 8 is electrically connected to the conductive layer 10, an unnecessary potential is applied to the conductive layer 10, which could cause a failure of another heating resistor element 2. Therefore, the functionality of the plug 8 as a fuse is low in Comparative Example 2.

### Example 1

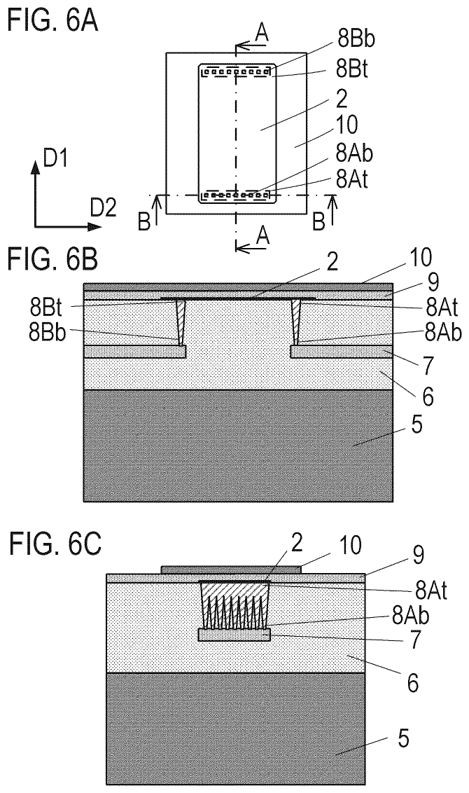

Next, a configuration of an element substrate 1 according to Example 1, which is an example of the present invention, will be described. FIGS. 6A to 6C illustrate a configuration of the element substrate 1 according to Example 1. FIG. 6A illustrates the periphery of one heating resistor element 2 in Example 1. FIG. 6B is a sectional view illustrating a cross section taken along a line A-A in FIG. 6A, the cross section being parallel to the first direction D1. FIG. 6C is a sectional view illustrating a cross section taken along a line B-B in FIG. 6A, the cross section being parallel to the second direction D2.

FIGS. 6A to 6C illustrate a first connecting portion 8At, which is a connection portion of the plug 8A to the heating resistor element 2 in the first end portion, and second connection portions 8Ab, which are connection portions of the plug 8A to the wiring layer 7 in the first end portion. Similarly, FIGS. 6A and 6B illustrate a first connection portion 8Bt, which is a connection portion of the plug 8B to the heating resistor element 2 in the second end portion, and second connection portions 8Bb, which are connection portions of the plug 8B to the wiring layer 7 in the second end portion. In FIG. 6A, the first connection portions 8At and 8Bt and the second connection portions 8Ab and 8Bb are indicated by dotted lines. Hereinafter, the configuration of the plug 8 will be described by focusing on the first connection portion 8At and the second connection portions 8Ab. Since the first connection portion 8Bt and the second connection portions 8Bb are configured in the same manner as the first connection portion 8At and the second connection portions 8Ab, detailed description thereof will be omitted.

In Example 1, one plug 8 is provided in each of the first end portion and the second end portion of the heating resistor element 2 in the first direction D1. The plug 8 in the first end portion of the heating resistor element 2 in the first direction D1 has one first connection portion 8At connected to the heating resistor element 2 and nine second connection portions 8Ab connected to the wiring layer 7. Similarly, the plug 8 in the second end portion of the heating resistor element 2 in the first direction D1 has one first connection portion 8Bt connected to the heating resistor element 2 and nine second connection portions 8Bb connected to the wiring layer 7. That is, the number of the second connection portions 8Ab of the plugs 8 provided in the first end portion of the heating resistor element 2 is greater than the number of the first connection portions 8At.

As illustrated in FIG. 6A, the plurality of second connection portions 8Ab are formed such that the entire region thereof overlaps the first connection portion 8At in the stacking direction. In Example 1, when viewed from the stacking direction, the area of the first connection portion 8At is greater than the sum of the areas of the plurality of second connection portions 8Ab. The plurality of second connection portions 8Ab are arranged at equal intervals from one another in the second direction D2.

The plugs 8 of Comparative Examples 1 and 2 extend from the wiring layer 7 to the heating resistor element 2 in approximately the same shape. On the other hand, as illustrated in FIGS. 6B and 6C, the plug 8 of Example 1 has a tapered shape such that the cross-sectional area thereof gradually increases from the second connection portions 8Ab on the wiring layer 7 side to the heating resistor element 2, and the plug 8 is integrated near the heating resistor element 2. That is, the plurality of second connection portions 8Ab are connected to one another near the heating resistor element 2, and form one first connection portion 8At. In other words, the plug 8 has branched (separated) end portions extending on the wiring layer 7 side to be connected to the wiring layer 7 at the plurality of second connection portions 8Ab.

In the configuration of Example 1, the plurality of second connection portions 8Ab of the plug 8 in contact with the wiring layer 7 are formed by being branched from one another so as to reduce the diameters and contact areas thereof. Therefore, when an excessive current flows due to a random failure, blow out occurs from the second connection portion 8Ab or a vicinity thereof as a starting point, and thus, the plug 8 functions as a fuse as in Comparative Example 1. In addition, the first connection portion 8At of the plug 8 in contact with the heating resistor element 2 is integrally formed so as to increase the contact area with the heating resistor element 2. Thus, the current path flowing through the heating resistor element 2 is similar to that in Comparative Example 2, and the energy generation efficiency can be increased compared to that of Comparative Example 1. As a result, according to the configuration of Example 1, it is possible to achieve high thermal energy generation efficiency while maintaining high reliability of the element substrate 1 by reducing the occurrence of a failure therein.

### Example 2

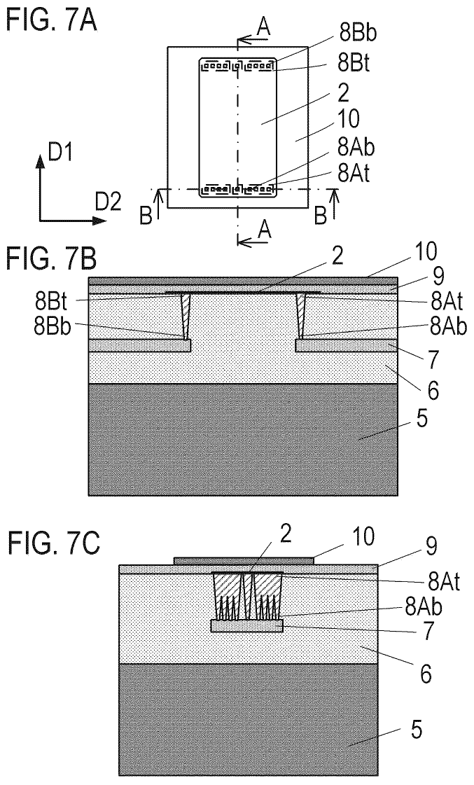

Next, a configuration of an element substrate 1 according to Example 2, which is an example of the present invention, will be described. FIGS. 7A to 7C illustrate a configuration of the element substrate 1 according to Example 2. FIG. 7A illustrates the periphery of one heating resistor element 2 in Example 2. FIG. 7B is a sectional view illustrating a cross section taken along a line A-A in FIG. 7A, the cross section being parallel to the first direction D1. FIG. 7C is a sectional view illustrating a cross section taken along a line B-B in FIG. 7A, the cross section being parallel to the second direction D2. In FIG. 7A, first connection portions 8At and 8Bt and second connection portions 8Ab and 8Bb are indicated by dotted lines. Hereinafter, the configuration of the plugs 8 will be described by focusing on the first connection portions 8At and the second connection portions 8Ab. Since the first connection portions 8Bt and the second connection portions 8Bb are configured in the same manner as the first connection portions 8At and the second connection portions 8Ab, detailed description thereof will be omitted.

In Example 2, three plugs 8 are provided side by side in the second direction D2 in each of the first end portion and the second end portion of the heating resistor element 2 in the first direction D1. Each of the plug 8 at one end and the plug 8 at the other end in the second direction D2 has branched end portions that extend on the wiring layer 7 side, and has one first connection portion 8At connected to the heating resistor element 2 and four second connection portions 8Ab connected to the wiring layer 7. The plug 8 in the center in the second direction D2 has no branched end portions, and has one first connection portion 8At connected to the heating resistor element 2 and one second connection portion 8Ab connected to the wiring layer 7. That is, three first connection portions 8At between the plugs 8 and the heating resistor element 2 and nine second connection portions 8Ab between the plugs 8 and the wiring layer 7 are formed in the first end portion of the heating resistor element 2 in the first direction D1. Similarly, three first connection portions 8Bt between the plugs 8 and the heating resistor element 2 and nine second connection portions 8Bb between the plugs 8 and the wiring layer 7 are formed in the second end portion of the heating resistor element 2 in the first direction D1. That is, the total number of the second connection portions 8Ab of the three plugs 8 provided in the first end portion of the heating resistor element 2 is greater than the total number of the first connection portions 8At.

As illustrated in FIG. 7A, the three first connection portions 8At are arranged side by side in the second direction D2, and the nine second connection portions 8Ab are also arranged side by side in the second direction D2. In Example 2, the placement pitch of the plurality of second connection portions 8Ab in the second direction D2 does not have equal intervals. The plurality of second connection portions 8Ab are arranged such that only the second connection portion 8Ab in the center in the second direction D2 has larger intervals with the other second connection portions 8Ab.

In the plug 8 at one end in the second direction D2, the four second connection portions 8Ab are formed such that the entire region thereof overlaps the first connection portion 8At in the stacking direction. Similarly, in the plug 8 at the other end in the second direction D2, the four second connection portions 8Ab are formed such that the entire region thereof overlaps the first connection portion 8At in the stacking direction. In each of the plugs 8 at one end and the other end in the second direction D2, when viewed from the stacking direction, the area of the first connection portion 8At is greater than the sum of the areas of the four second connection portions 8Ab. In the single plug 8 in the center in the second direction D2, the second connection portion 8Ab is formed such that the entire region thereof overlaps the first connection portion 8At in the stacking direction. In the single plug 8 in the center, when viewed from the stacking direction, the area of the first connection portion 8At is greater than the area of the second connection portion 8Ab. That is, the sum of the areas of the first connection portion 8At of each of the plurality of plugs 8 arranged in the first end portion of the heating resistor element 2 is greater than the sum of the areas of the second connection portions 8Ab.

As illustrated in FIGS. 7B and 7C, the individual plug 8 of Example 2 is formed in a tapered shape such that the thickness thereof gradually increases from at least one second connection portion 8Ab on the wiring layer 7 side to the first connection portion 8At on the heating resistor element 2 side. Among the second connection portions 8Ab, the four second connection portions 8Ab at each end in the second direction D2 are connected to one another near the heating resistor element 2, and form one first connection portion 8At. Among the second connection portions 8Ab, the one second connection portion 8Ab in the center in the second direction D2 is formed to extend to the corresponding one of the first connection portions 8At, without being connected to the other second connection portions 8Ab. In other words, two of the three first connection portions 8At are each branched into four second connection portions 8Ab and connected to the wiring layer 7, and the other first connection portion 8At is connected to the wiring layer 7, without being branched.

As compared with the configuration of Example 1, in the configuration of Example 2, the second connection portion 8Ab in the center is positioned to be apart from the other second connection portions 8Ab, and the plug 8 having the second connection portion 8Ab in the center is independently placed to be apart from the other plugs 8. Therefore, when a random failure occurs in the heating resistor element 2, the current can be concentrated on the center plug 8. Thus, the center plug 8 is more likely to blow out and functions as a fuse serving as a starting point. That is, according to the configuration of Example 2, it is possible to achieve high thermal energy generation efficiency and to further increase the reliability of the element substrate 1 as compared with the configuration of Example 1.

### Example 3

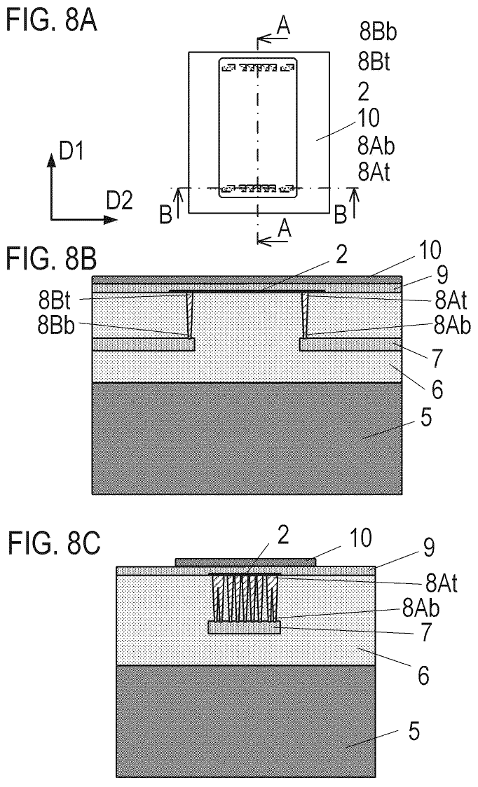

Next, a configuration of an element substrate 1 according to Example 3, which is an example of the present invention, will be described. FIGS. 8A to 8C illustrate a configuration of the element substrate 1 according to Example 3. FIG. 8A illustrates the periphery of one heating resistor element 2 in Example 3. FIG. 8B is a sectional view illustrating a cross section taken along a line A-A in FIG. 8A, the cross section being parallel to the first direction D1. FIG. 8C is a sectional view illustrating a cross section taken along a line B-B in FIG. 8A, the cross section being parallel to the second direction D2. In FIG. 8A, first connection portions 8At and 8Bt and second connection portions 8Ab and 8Bb are indicated by dotted lines. Hereinafter, the configuration of the plugs 8 will be described by focusing on the first connection portions 8At and the second connection portions 8Ab. Since the first connection portions 8Bt and the second connection portions 8Bb are configured in the same manner as the first connection portions 8At and the second connection portions 8Ab, detailed description thereof will be omitted.

In Example 3, seven plugs 8 are provided side by side in the second direction D2 in each of the first end portion and the second end portion of the heating resistor element 2 in the first direction D1. Each of the plug 8 at one end and the plug 8 at the other end in the second direction D2 has branched end portions that extend on the wiring layer 7 side, and has one first connection portion 8At connected to the heating resistor element 2 and two second connection portions 8Ab connected to the wiring layer 7. Each of the five plugs 8 in the central part in the second direction D2 has no branched end portions, and has one first connection portion 8At connected to the heating resistor element 2 and one second connection portion 8Ab connected to the wiring layer 7. That is, seven first connection portions 8At between the plugs 8 and the heating resistor element 2 and nine second connection portions 8Ab between the plugs 8 and the wiring layer 7 are formed in the first end portion of the heating resistor element 2 in the first direction D1. Similarly, seven first connection portions 8Bt between the plugs 8 and the heating resistor element 2 and nine second connection portions 8Bb between the plugs 8 and the wiring layer 7 are formed in the second end portion of the heating resistor element 2 in the first direction D1. That is, the total number of the second connection portions 8Ab is greater than the total number of the first connection portions 8At in the seven plugs 8 provided in the first end portion of the heating resistor element 2.

As illustrated in FIG. 8A, the seven first connection portions 8At are arranged side by side in the second direction D2, and the nine second connection portions 8Ab are also arranged side by side in the second direction D2. In Example 3, the placement pitch of the plurality of second connection portions 8Ab in the second direction D2 does not have equal intervals. The plurality of second connection portions 8Ab are arranged such that the interval between the second connection portions 8Ab positioned at the first and second from one end in the second direction D2 and the interval between the second connection portions 8Ab positioned at the eighth and ninth from the one end in the second direction D2 are smaller than the intervals between the other second connection portions 8Ab.

In the plug 8 at one end in the second direction D2, the two second connection portions 8Ab are formed such that the entire region thereof overlaps the first connection portion 8At in the stacking direction. Similarly, in the plug 8 at the other end in the second direction D2, the two second connection portions 8Ab are formed such that the entire region thereof overlaps the first connection portion 8At in the stacking direction. In each of the plug 8 at one end and the plug 8 at the other end in the second direction D2, when viewed from the stacking direction, the area of the first connection portion 8At is greater than the sum of the areas of the two second connection portions 8Ab. In each of the five plugs 8 in the central part in the second direction D2, the second connection portion 8Ab is formed such that the entire region thereof overlaps the first connection portion 8At in the stacking direction. In each of the plugs 8 in the central part, when viewed from the stacking direction, the area of the first connection portion 8At is greater than the area of the second connection portion 8Ab.

As illustrated in FIGS. 8B and 8C, the individual plug 8 of Example 3 is formed in a tapered shape such that the thickness thereof gradually increases from at least one second connection portion 8Ab on the wiring layer 7 side to the first connection portion 8At on the heating resistor element 2 side. Among the second connection portions 8Ab, the two second connection portions 8Ab at each end in the second direction D2 are connected to each other near the heating resistor element 2, and form one first connection portion 8At. Among the second connection portions 8Ab, each of the five second connection portions 8Ab in the central part in the second direction D2 is formed to extend to the corresponding one of the first connection portions 8At, without being connected to the other second connection portions 8Ab. In other words, two of the seven first connection portions 8At are each branched into two second connection portions 8Ab and connected to the wiring layer 7, and the other five first connection portions 8At are connected to the wiring layer 7, without being branched.

In the configuration of Example 3, as compared with the total of four second connection portions 8Ab provided at both ends in the second direction D2, the other five second connection portions 8Ab are positioned to be apart from one another, and the plugs 8 in the central part, which have these five second connection portions 8Ab positioned to be apart from one another, are independently placed to be apart from the other plugs 8. Therefore, when a random failure occurs in the heating resistor element 2, the five plugs 8 in the central part are more likely to blow out and function as a fuse that is likely to be a starting point. That is, according to the configuration of Example 3, it is possible to achieve high thermal energy generation efficiency, and since the number of plugs 8 functioning as fuses can be increased as compared with the configuration of Example 2, it is possible to further improve the reliability of the element substrate 1.

### Plug Manufacturing Method

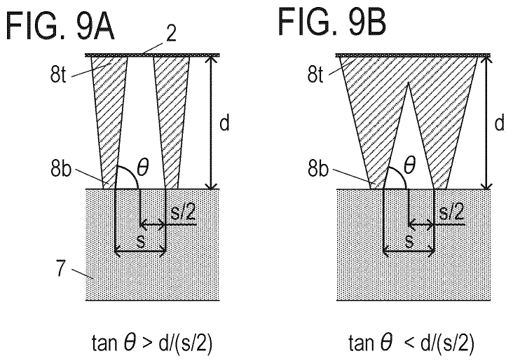

Next, a method for manufacturing the plugs 8 according to the above-described examples will be described. FIGS. 9A and 9B are explanatory diagrams illustrating a method for manufacturing the plugs 8. FIG. 9A illustrates a case where a plurality of second connection portions 8b are not connected, and FIG. 9B illustrates a case where a plurality of second connection portions 8b are connected and form a common first connection portion 8t. In FIGS. 9A and 9B, some layers such as the intermediate layer 6 are not illustrated for simplicity. The manufacturing method described below is merely an example, and the present invention is not limited thereto. Hereinafter, the first connection portion 8At and the first connection portion 8Bt are collectively referred to as a first connection portion 8t, and the second connection portion 8Ab and the second connection portion 8Bb are collectively referred to as a second connection portion 8b.

A distance between the wiring layer 7 and the heating resistor element 2 in the stacking direction is defined as d, a distance (space) in the second direction D2 between the second connection portions 8b of the plugs 8 adjacent to each other is defined as s, and an inclination angle (plug angle) of the plug 8 is defined as θ. The inclination angle of the plug 8 is an angle formed by the upper surface (the surface connected to the plug 8) of the wiring layer 7 and the side portion (the portion extending from the first connection portion 8t to the second connection portion 8b) of the plug 8 when the element substrate 1 is viewed from the first direction D1.

In a case where the plurality of plugs 8 are not connected to each other on the heating resistor element 2 side and the plugs 8 independent of each other are formed, the plug angle θ has a relationship of tan θ>d/(s/2) as illustrated in FIG. 9A. In a case where the plugs 8 are connected to each other on the heating resistor element 2 side and one plug 8 having a plurality of second connection portions 8b is formed, the plug angle θ has a relationship of tan θ<d/(s/2) as illustrated in FIG. 9B. Since the shape of the plug 8 is determined by the shape of the hole formed in the intermediate layer 6 by etching or the like, the plug 8 can be formed into a tapered shape and can be, as needed, connected on the heating resistor element 2 side by adjusting the etching conditions or the like.

As described above, according to the configurations of the above-described examples, it is possible to provide a highly reliable liquid ejection head substrate including a heating resistor with increased thermal energy generation efficiency. Note that the present invention is not limited to the above-described examples, and various modifications and variations can be made without departing from the spirit and scope of the invention. For example, while the plug 8 arranged in the central part in the second direction D2 is configured to function as a fuse in Examples 2 and 3, the plug 8 arranged at the end in the second direction D2 may be configured to function as a fuse. In addition, for example, in the configuration of Example 2, the first connection portions 8At of the three plugs 8 provided in the first end portion of the element substrate 1 in the first direction D1 may be connected to one another and form one plug 8.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-211136, filed on Dec. 14, 2023, which is hereby incorporated by reference herein in its entirety.

What is claimed is:

1. An element substrate for a liquid ejection head that ejects liquid, the element substrate comprising:
a heating resistor element configured to generate energy for ejecting liquid by generating heat;
a wiring layer configured to supply electric power to the heating resistor element; and
a connection member including a first connection portion connected to the heating resistor element and a plurality of second connection portions connected to the wiring layer and configured to electrically connect the heating resistor element and the wiring layer,
wherein the connection member has branched end portions that extend, on a wiring layer side thereof, and is connected to the wiring layer by the plurality of second connection portions.

2. The element substrate according to claim 1, wherein the number of the second connection portions of the connection member is greater than the number of the first connection portions.

3. The element substrate according to claim 1, wherein the connection member has a tapered shape such that a cross-sectional area of the connection member gradually increases from each of the plurality of second connection portions to the heating resistor element.

4. The element substrate according to claim 1, wherein an area of the first connection portion is greater than an area of the second connection portion.

5. The element substrate according to claim 1, wherein an area of the first connection portion is greater than a sum of areas of the plurality of second connection portions.

6. The element substrate according to claim 1, wherein the second connection portion is placed at a position where an entire region of the second connection portion overlaps the first connection portion in a plan view of the element substrate.

7. The element substrate according to claim 1,
wherein the connection member is provided in each of a first end portion and a second end portion of the heating resistor element in a first direction in a plan view of the element substrate, and
wherein the plurality of second connection portions are arranged side by side in a second direction intersecting the first direction in each of the first end portion and the second end portion.

8. The element substrate according to claim 7, wherein a plurality of the connection members are provided side by side in the second direction in each of the first end portion and the second end portion.

9. The element substrate according to claim 8, wherein a total number of the second connection portions of the plurality of the connection members provided side by side in the second direction is greater than a total number of the first connection portions.

10. The element substrate according to claim 8, wherein, in the plurality of the connection members provided side by side in the second direction, a sum of areas of the first connection portion of each of the connection members is greater than a sum of areas of the second connection portions of each of the connection members.

11. The element substrate according to claim 8,
wherein the element substrate is a stacked body configured by stacking a plurality of functional layers in a stacking direction, and
wherein the connection member satisfies tan θ<d/(s/2), where d represents a distance between the heating resistor element and the wiring layer in the stacking direction, s represents a distance between the second connection portions adjacent to each other in the second direction, and θ represents an angle formed by a surface of connection of the wiring layer to the connection member and a side portion of the connection member extending from the first connection portion to the second connection portion.

12. The element substrate according to claim 1, wherein the connection member includes a film formed of tungsten.

13. The element substrate according to claim 1, wherein the heating resistor element contains a tantalum silicon nitride material.

14. The element substrate according to claim 1, wherein the element substrate is a stacked body configured by a plurality of functional layers, and includes a base substrate, an intermediate layer which is laminated on the base substrate and in which the wiring layer is formed and moreover on an upper surface of which the heating resistor element is formed, an insulating layer which covers the heating resistor element, and moreover a conductive layer which is laminated on the insulating layer.

15. The element substrate according to claim 14, wherein the conductive layer contains iridium.

16. An element substrate for a liquid ejection head that ejects liquid, the element substrate comprising:
a heating resistor element configured to generate energy for ejecting liquid by generating heat;
a wiring layer configured to supply electric power to the heating resistor element; and
a connection member including a first connection portion connected to the heating resistor element and a second connection portion connected to the wiring layer, and configured to electrically connect the heating resistor element and the wiring layer,
wherein an area of the first connection portion is greater than an area of the second connection portion.

17. The element substrate according to claim 16,
wherein the connection member has separated end portions on a wiring layer side thereof and is connected to the wiring layer by a plurality of the second connection portions, and
wherein an area of the first connection portion is greater than a sum of areas of the plurality of the second connection portions.

18. The element substrate according to claim 16,
wherein the connection member is provided in each of a first end portion and a second end portion of the heating resistor element in a first direction in a plan view of the element substrate, and
wherein a plurality of the connection members are provided side by side in a second direction intersecting the first direction in each of the first end portion and the second end portion.

19. The element substrate according to claim 18,
wherein the element substrate is a stacked body configured by stacking a plurality of functional layers in a stacking direction, and
wherein the connection member satisfies tan θ<d/(s/2), where d represents a distance between the heating resistor element and the wiring layer in the stacking direction, s represents a distance between the second connection portions adjacent to each other in the second direction, and θ represents an angle formed between a surface of connection of the wiring layer to the connection member and a side portion of the connection member extending from the first connection portion to the second connection portion.

20. A liquid ejection head comprising an element substrate including:
a heating resistor element configured to generate energy for ejecting liquid by generating heat;
a wiring layer configured to supply electric power to the heating resistor element; and
a connection member including a first connection portion connected to the heating resistor element and a plurality of second connection portions connected to the wiring layer and configured to electrically connect the heating resistor element and the wiring layer,
wherein the connection member has branched end portions that extend, on a wiring layer side thereof, and is connected to the wiring layer by the plurality of second connection portions.
